(19) United States
(12) Patent Application Publication
(10) Pub. No.: US 2025/0170635 A1
(43) Pub. Date: May 29, 2025

(54) Knockout Punch Tool with Draw Stud

(71) Applicant: Milwaukee Electric Tool Corporation, Brookfield, WI (US)

(72) Inventors: Jacob J. Konieczka, Wauwatosa, WI (US); Julian L. Kinneavy, Wauwatosa, WI (US); Ian H.A. Blair, Wauwatosa, WI (US)

(21) Appl. No.: 19/036,681

(22) Filed: Jan. 24, 2025

Related U.S. Application Data
(63) Continuation of application No. PCT/US2024/049563, filed on Oct. 2, 2024.
(60) Provisional application No. 63/676,695, filed on Jul. 29, 2024.
(60) Provisional application No. 63/587,541, filed on Oct. 3, 2023.

(51) Int. Cl. B21D 28/34; B21D 28/24; B26F 1/38

(52) U.S. Cl. CPC B21D 28/343; B21D 28/246; B26F 1/386

(57) ABSTRACT

A knockout punch tool set is provided. The knockout punch tool set includes a punch, a die, a draw stud, and a driving tool. The draw stud is configured to be used with both a powered and a manual driving tool. The draw stud includes a driving end with a recess. The recess of the draw stud is couplable to a square drive to allow for use with the powered driving tool. The driving end of the draw stud further includes outer surfaces positioned around the recess to allow for engagement with a manual driving tool. In various embodiments, the punch tool set includes a step bit couplable to the draw stud.

### CROSS-REFERENCE TO RELATED PATENT APPLICATIONS

The present application is a continuation of International Application No. PCT/US2024/049563 filed on Oct. 2, 2024, which claims the benefit of and priority to U.S. Provisional Application No. 63/676,695 filed on Jul. 29, 2024, and to U.S. Provisional Application No. 63/587,541 filed on Oct. 3, 2023, which are incorporated herein by reference in their entireties.

### BACKGROUND OF THE INVENTION

The present invention relates generally to the field of knockout punch tools and more particularly to a draw stud for use with a knockout punch tool set. The knockout punch tool and draw stud can be used with both powered knockout drivers (e.g., impact drill, impact wrench, etc.) and manual knockout drivers (e.g., manual ratchet wrench, etc.).

As will be generally understood, knockout drivers are typically used in combination with a punch and die set to form apertures within material, such as sheets of steel material. The punching process includes providing a force between the die and punch, such that the punch pierces the sheet material and forms the desired aperture. The force can be produced in a number of ways, such as manually, hydraulically, etc. Typically, manual embodiments are limited by the size of hole they can create while some hydraulic powered systems can be bulky.

### SUMMARY OF THE INVENTION

One embodiment of the invention relates to a knockout punch tool set. The knockout punch tool set includes a draw stud, a punch, a die, a drive, and a powered tool configured to rotate the drive. The draw stud includes a driving end, the driving end includes a recess. The draw stud further includes a front end opposing the driving end and a threaded portion positioned between the driving end and the front end. The punch is couplable to the draw stud. The drive is positioned within the recess of the driving end.

Another embodiment of the invention relates to a draw stud for a knockout punch tool. The draw stud includes a driving end, a front end opposing the driving end, and a threaded portion positioned and extending between the driving end and the front end. The driving end includes a recess. The front end of the draw stud includes a bore. The driving end of the draw stud has a polygonal shape.

Another embodiment of the invention relates to a knockout punch tool set. The knockout punch tool set includes a draw stud, a punch, a die, a connector, and a tool configured to rotate the draw stud. The draw stud includes a driving end, a front end opposing the driving end, and a threaded portion positioned between the driving end and the front end of the draw stud. The threaded portion extends along a longitudinal axis of the draw stud. The punch is coupled adjacent to the front end of the draw stud. The connector is coupled to the front end of the draw stud. The punch is positioned between the connector and the draw stud. The die is coupled adjacent to the driving end of the draw stud.

In a specific embodiment, the connector is a hex nut. In a specific embodiment, the threaded portion of the draw stud includes a plurality of threads having a trapezoidal cross-sectional profile. In a specific embodiment, the draw stud includes a drilling end that opposes the driving end. A bore is defined in the drilling end. The bore is couplable to a step bit. In a specific embodiment, the step bit includes a drilling end, an engagement end that is received within the bore of the draw stud, and a reamer positioned between the drilling end and the engagement end of the step bit.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a right perspective view of a knockout tool set, according to an exemplary embodiment.

FIG. 2 is a left perspective view of the knockout tool set of FIG. 1, according to an exemplary embodiment.

FIG. 3 is a partially exploded view of a knockout tool system with an impact driver, according to an exemplary embodiment.

FIG. 4 is a partially exploded view of a knockout tool system with an impact wrench, according to an exemplary embodiment.

FIG. 5 is a partially exploded view of a knockout tool system with a manual ratchet wrench, according to an exemplary embodiment.

FIG. 6 is an exploded view of the knockout tool set of FIG. 1, according to an exemplary embodiment.

FIG. 7 is a perspective view of a draw stud and a drive component of the knockout tool set of FIG. 1, according to an exemplary embodiment.

FIG. 8 is a rear perspective view of the draw stud of FIG. 7, according to an exemplary embodiment.

FIG. 9 is a front perspective view of the draw stud and a step bit of the knockout tool set of FIG. 1, according to an exemplary embodiment.

FIG. 10 is a front perspective view of the draw stud of the knockout tool set of FIG. 1, according to an exemplary embodiment.

FIG. 11 is a plan view of a step bit for a knockout tool set, according to another exemplary embodiment.

FIG. 12 is a perspective view of a draw stud, according to another exemplary embodiment.

FIG. 13 is a perspective view of a knockout tool set, according to another exemplary embodiment.

FIG. 14 is a cross-sectional view of a knockout tool set, according to another exemplary embodiment.

FIG. 15 is a perspective view of a knockout tool set, according to another exemplary embodiment.

FIG. 16 is a partially exploded view of a knockout tool set, according to another exemplary embodiment.

FIG. 17 is a perspective view of a knockout tool set, according to another exemplary embodiment.

FIG. 18A is a partially exploded view of a knockout tool set, according to another exemplary embodiment.

FIG. 18B is a threaded adapter of the knockout tool set of FIG. 18A, according to an exemplary embodiment.

FIG. 19A is a partially exploded view of a knockout tool set, according to another exemplary embodiment.

FIG. 19B is a knockout tool set, according to another exemplary embodiment.

FIG. 19C is a partially exploded view of a knockout tool set, according to another exemplary embodiment.

FIG. 19D is a side view of a nut for a knockout tool set, according to another exemplary embodiment.

FIG. 19E is a partially exploded view of a knockout tool set, according to another exemplary embodiment.

FIG. 19F is a perspective view of a portion of a knockout tool set, according to another exemplary embodiment.

FIG. 19G is a partially exploded view of a knockout tool set, according to another exemplary embodiment.

FIG. 19H is a partially exploded view of a knockout tool set, according to another exemplary embodiment.

FIG. 19I is a perspective view of a portion of a knockout tool set, according to another exemplary embodiment.

FIG. 20A is a perspective view of a portion of a knockout tool set, according to another exemplary embodiment.

FIG. 20B is a perspective view of a portion of a knockout tool set, according to another exemplary embodiment.

FIG. 20C is a cross-sectional view of a portion of a knockout tool set, according to another exemplary embodiment.

FIG. 20D is a perspective view of a portion of a knockout tool set, according to another exemplary embodiment.

FIG. 20E is a perspective view of a portion of a knockout tool set, according to another exemplary embodiment.

FIG. 20F is a perspective view of a portion of a knockout tool set, according to another exemplary embodiment.

FIG. 20G is a perspective view of a portion of a knockout tool set, according to another exemplary embodiment.

FIG. 20H is a perspective view of a portion of a knockout tool set, according to another exemplary embodiment.

FIG. 21A is a side view of a portion of a knockout tool set, according to another exemplary embodiment.

FIG. 21B is a side view of a portion of a knockout tool set, according to another exemplary embodiment.

FIG. 21C is a perspective view of a portion of a knockout tool set, according to another exemplary embodiment.

FIG. 22A is a portion of a knockout tool set, according to another exemplary embodiment.

FIG. 22B is a side view of a portion of a knockout tool set, according to another exemplary embodiment.

FIG. 22C is a portion of a knockout tool set, according to another exemplary embodiment.

FIG. 23 is a cross-sectional view of a knockout tool set moving from a first position to a second position, according to an exemplary embodiment.

FIG. 24 is a cross-sectional view of a knockout tool set moving from a first position to a second position, according to another exemplary embodiment.

FIG. 25 is a cross-sectional view of a knockout tool set, according to an exemplary embodiment.

FIG. 26 is a cross-sectional view of a knockout tool set moving from a first position to a second position, according to an exemplary embodiment.

### DETAILED DESCRIPTION

Referring generally to the figures, various embodiments of a knockout punch tool set and/or knockout punch tool systems are shown. Various embodiments of the knockout punch tool set discussed herein include an innovative draw stud design. As will be generally understood, knockout punch tool sets typically include a punch and die set that is used with a draw stud to form apertures within material by applying force either manually or hydraulically. In contrast to conventional manual draw studs that only include a bolt head or hydraulic draw studs that frequently include threading on both ends, the draw stud designs discussed herein are capable of being used with both manual knockout drivers (e.g., manual ratchet, etc.) and powered knockout drivers (e.g., impact drill, impact wrench, etc.). The combined functionality is useful for electricians, utility workers and/or lineman who work in environments where it may be difficult to carry around multiple knockout punch tool sets and/or a large number of tools.

In various embodiments, the draw stud includes a recess or bore on a driving end allowing for engagement with a drive component, such as a square drive that can connect with a power tool such as an impact drill or an impact wrench. In such an embodiment, the recess is positioned within the bolt or hex head end such that the draw stud can still be driven manually by a driver such as a ratchet wrench. In various embodiments, the draw stud includes a recess or bore on a drilling end allowing for engagement with a step drill bit. This combined functionality further allows electricians, utility workers, etc. to drill the required pilot hole without a separate drilling tool increasing working efficiency. In a specific embodiment, the step drill bit includes an integrated reamer to allow for quick and easy removal of sharp edges of the pilot hole which Applicant believes allows for easier insertion of the draw stud through the pilot hole.

In various embodiments, the draw stud includes threading with a large thread cross-sectional area. Applicant believes use of the large thread cross-sectional area reduces premature impact from powered knockout drivers (e.g., impact drill, impact wrench, etc.). In various specific embodiments, the draw stud includes an ACME thread (i.e., threads have a trapezoidal cross-sectional profile). In various specific embodiments, the draw thud includes threading with a large thread cross-sectional area and a reduced diameter. As will be generally understood, the necessary torque from the powered knockout drivers is reduced when the diameter of the draw stud is decreased.

In various embodiments, the knockout punch tool and/or knockout punch tool system includes a connector such as a nut that is coupled to the draw stud. Applicant has found that use of a connector reduces the likelihood of draw stud or punch failure. In other words, the connector or nut becomes the point of failure or consumable component. In various specific embodiments, the connector is a hex nut. In various specific embodiments, the punch includes a recess to receive the connector. In various specific embodiments, the knockout punch tool system includes a spacer between the punch and connector. In such embodiments, Applicant has found an increase in friction between the punch and connector prevents separation. In various specific embodiments, the connector and the punch include mating features to lock the connector and punch together. In various specific embodiments, the connector is an adapter such as a threaded adapter.

Applicant has found that after punching a hole, the cutter of punch has energy and continues to move along the shaft of the draw stud resulting in unwanted engagement with the die. In other words, the punch bottoms out and impacts the die which may deform the punch and/or damage the punch and die. In various embodiments, the draw stud includes a threadless zone. Applicant believes the threadless zone prevents the punch from unwanted continued movement into the die. In various specific embodiments, the draw stud includes a reduced diameter zone. In such embodiments, the punch spins freely after punching. In various specific embodiments, the punch includes a flange along a portion of the outer surface. After cutting, the flange of the punch prevents the punch from unwanted engagement/bottoming out with the die because the flange engages the die before the cutting portion of the punch.

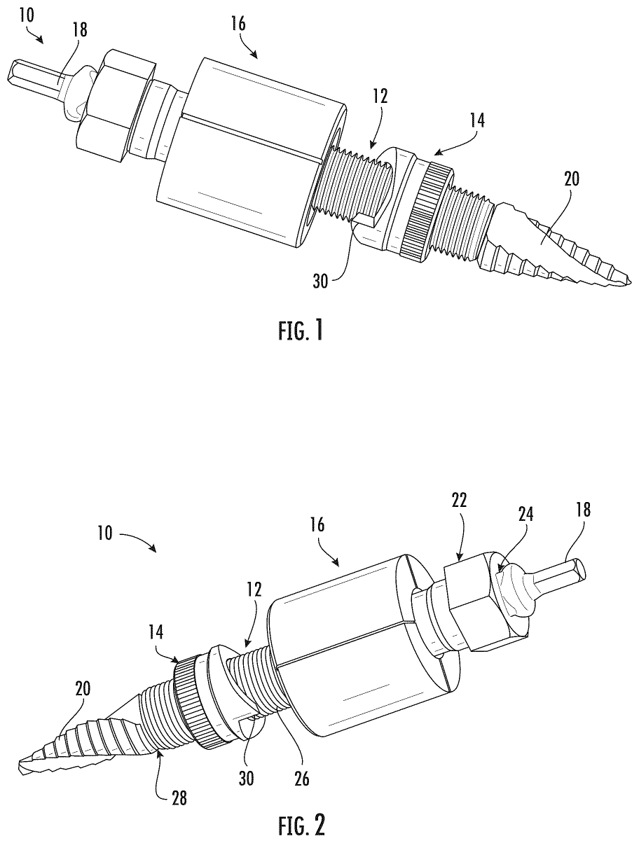

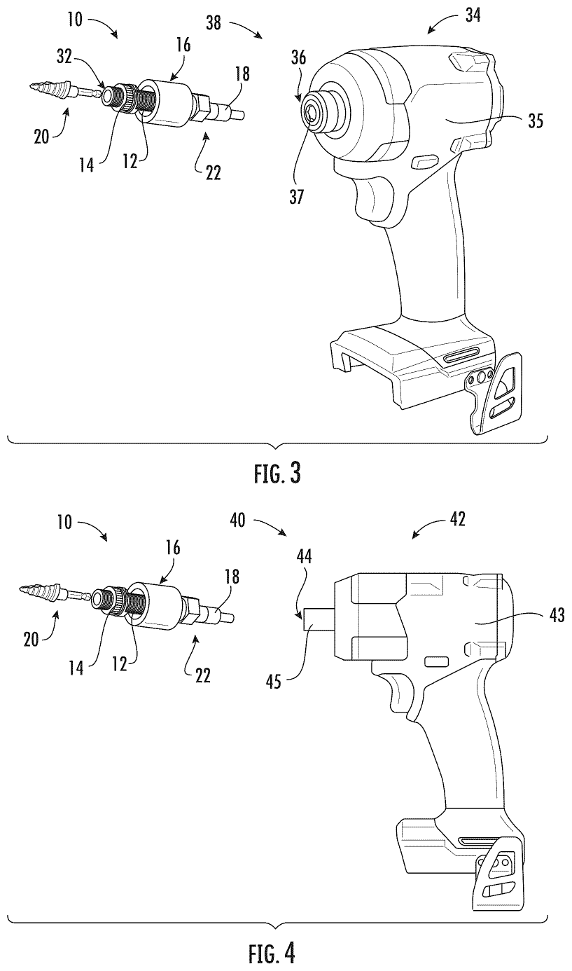

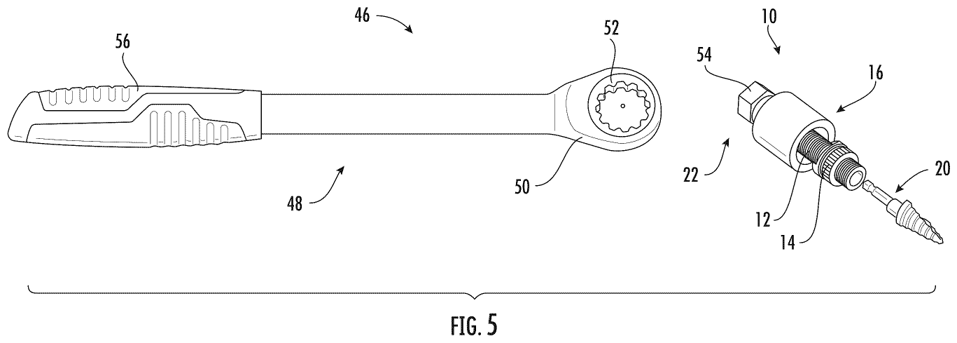

Referring to FIGS. 1-2, various aspects of a knockout tool set, shown as a knockout punch tool set 10 are shown. Knockout punch tool set 10 includes a draw stud 12, a punch 14, and a die 16. As will be generally understood, the punching process includes providing a force between the die 16 and punch 14, such that the punch 14 pierces a sheet of material or workpiece and forms a desired aperture within the material. The punching process typically includes making a pilot hole through the piece of material and then placing the die 16 on the draw stud 12 which is inserted through the pilot hole. In other words, die 16 is couplable to draw stud 12. The punch 14 is then coupled (e.g., threaded on) to the draw stud 12 on the opposing side of the material and/or workpiece. In other words, the punch 14 is couplable to draw stud 12. As will be discussed in greater detail below, an end of the draw stud 12 is then engaged by a manual tool (see e.g., ratchet wrench 48 in FIG. 5) or powered tool (see e.g., impact drill 34 in FIG. 3, impact wrench 42 in FIG. 4) and turned or tightened such that the punch 14 moves toward die 16 and eventually pierces and cuts through the material and/or workpiece. In other words, driving end of draw stud 12 is configured to engaged by a manual tool. Specifically, punch 14 includes at least one cutting projection or edge 30. In a specific embodiment, punch 14 includes a pair of cutting projections 30.

Draw stud 12 includes a driving end, shown as a bolt or hex end 22. Hex end 22 of draw stud 12 includes a bore or recess 24. In various embodiments, knockout punch tool set 10 further includes a drive component, shown as a square drive 18 configured to engage and/or couple to hex end 22 of draw stud 12. In various embodiments, drive 18 is positioned within recess 24 of driving end 22. In various embodiments, recess 24 is shaped to receive square drive 18. Square drive 18 allows for knockout punch tool set 10 and specifically draw stud 12 to be driven by a power tool. In other words, the powered tool is configured to rotate drive 18. In a specific embodiment, square drive 18 is a ½ inch square drive. In other embodiments, square drive has a different size (e.g., ¼ inch, ¾ inch, 1 inch, etc.). Draw stud 12 further includes a threaded section 26 positioned between the hex end 22 and an opposing front or bit end 28. Bit end 28 includes a bore 32 (see e.g., FIG. 3) configured to receive and/or couple to a step bit 20. In various specific embodiments, draw stud 12 includes bore 32 on a front end, and bore 32 is couplable to step bit 20. Step bit 20 can be used to make the pilot hole for knockout punch tool set 10 without having to change the tool being used.

Referring to FIGS. 3-5, various knockout tool systems are shown according to exemplary embodiments. As shown in FIG. 3, a knockout tool system 38 includes an impact drill or driver 34 that can be utilized with knockout punch tool set 10. As will be generally understood, impact drill 34 is capable of outputting a higher torque level than conventional drills. Impact drill 34 includes a housing 35 that contains various driving components (e.g., motor, power source, drive assembly, etc.). Housing 35 includes a bore 36. When knockout tool system 38 is assembled, square drive 18 is received within and coupled to bore 36 of the impact drill 34. In various embodiments, an adapter 37 is positioned within bore 36 of impact drill 34. In specific embodiments, adapter 37 allows draw stud 12 to be driven by a ¼ inch to ½ inch adapter in a ¼ inch impact drill 34.

As shown in FIG. 4, a knockout tool system 40 includes an impact wrench, shown as a high torque impact wrench 42 that can be utilized with knockout punch tool set 10. As will be generally understood, impact wrench 42 is capable of outputting a higher rotational torque than conventional drills. In various specific embodiments, the powered tool utilized with the knockout tool system is one of impact drill 34 and impact wrench 40.

Impact wrench 42 includes a housing 43 that contains various driving components (e.g., motor, power source, drive assembly, etc.). Housing 43 includes a bore 44. When knockout tool system 40 is assembled, square drive 18 is received within and coupled to bore 44 of the impact wrench 42. In specific embodiments, a socket 45 allows draw stud 12 to be driven in a ½ inch impact wrench 42. In such embodiments, the socket 45 is a 1 inch socket or a ½ inch socket.

As shown in FIG. 5, a knockout tool system 46 includes a manual wrench, shown as a ratchet wrench 48 that can be utilized with knockout punch tool set 10. Ratchet wrench 48 includes a head 50 coupled to an end of a handle 56. Ratchet wrench 48 further includes a ratchet mechanism. A workpiece engagement structure 52 is supported by and coupled to head 50 of ratchet wrench 48. As will be generally understood, a ratchet mechanism is a mechanical structure that allows for free or unrestricted rotation of handle 56 around workpiece engagement structure 52 in a first direction and allows for restricted or driving rotation of handle 56 around workpiece engagement structure 52 in a second direction opposing direction. The ratchet mechanism includes various ratcheting components (gear, pawl, etc.) that allow for unrestricted rotation in one direction and driving in the opposing direction.

Ratchet wrench 48 and specifically workpiece engagement structure 52 can be used to manually engage or tighten bolt end 22 of draw stud 12 that includes outer surfaces 54. In various embodiments, bolt end 22 has a polygonal shape (i.e., triangular, square, pentagonal, etc.). In specific embodiments, bolt end 22 has a generally hexagonal shape. In various specific embodiments, driving or bolt end 22 has a generally hexagonal shape with recess 24 defined in a middle of driving end 22. In specific embodiments where bolt end 22 has a generally hexagonal shape, there are six outer surfaces 54. In various specific embodiments, driving or bolt end 22 includes six radially outward facing surfaces 54. In other embodiments where bolt end 22 has a different shape, there may be a different number of outer surfaces 54 (e.g., square shape has four surfaces, octagonal shape has eight surfaces, etc.). In various embodiments, driving or bolt end 22 includes a plurality of outer surfaces. In such embodiments, the plurality of outer surfaces together define the shape of the driving end 22.

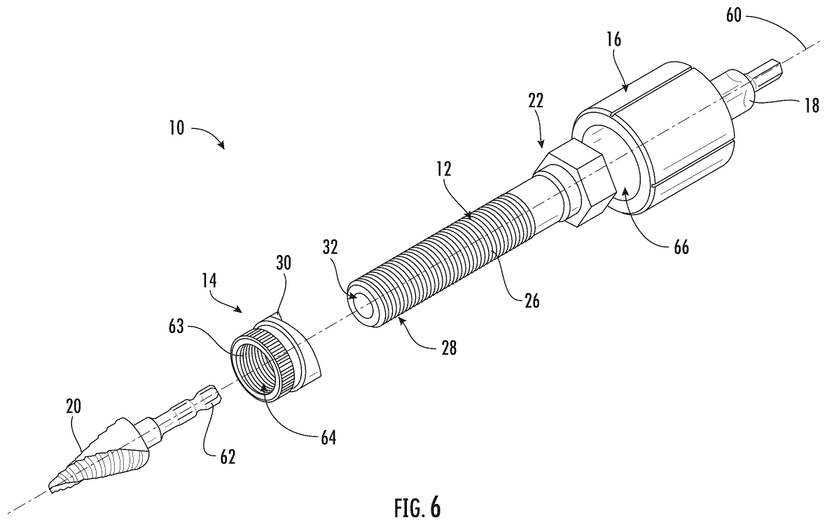

Referring to FIG. 6, an exploded view of knockout punch tool set 10 is shown, according to an exemplary embodiment. Draw stud 12 extends along a longitudinal axis 60. Step bit 20 includes an engagement end 62 that is received within bore 32 of bit end 28 when step bit 20 is coupled to draw stud 12. Punch 14 includes a bore or passageway 64 extending through punch 14. In a specific embodiment, passageway 64 is centered within punch 14 and about longitudinal axis 60. Passageway 64 of punch 14 includes threading 63 on an inner surface. Threading 63 engages the threaded section 26 of draw stud 12 such that punch 14 moves towards die 16 when the draw stud 12 is turned in a tightening direction. Die 16 similarly includes a passageway 66 that extends through die 16, allowing die 16 to extend around and couple to draw stud 12 during the punching process.

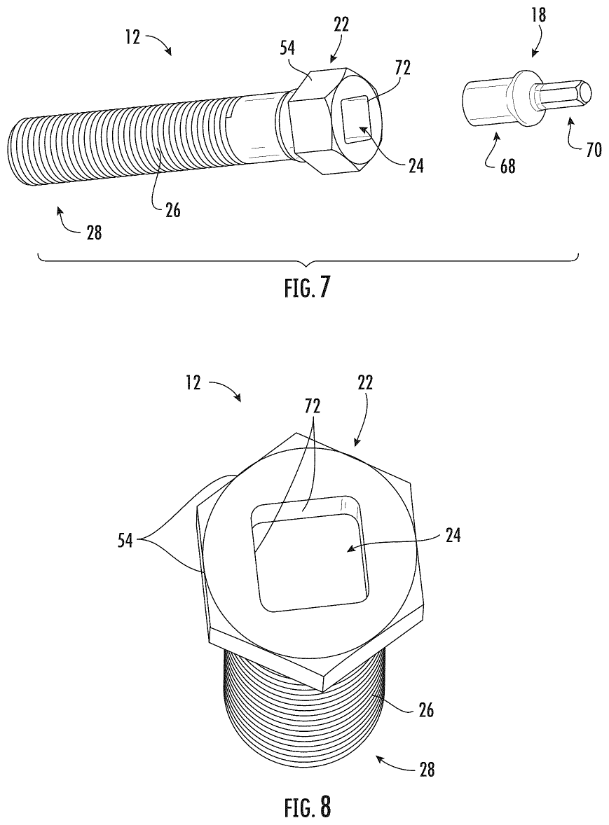

Referring to FIGS. 7-10, details of the draw stud 12 are shown according to an exemplary embodiment. As shown in FIGS. 7-8, in a specific embodiment, recess 24 is shaped like a rectangular prism or cube. In such an embodiment, recess 24 includes four inner surfaces 72 that engage with an engagement end, shown as square end 68 of square drive 18. In other words, in such embodiments, recess 24 includes four inward facing surfaces 72. Square drive 18 further includes a driving end 70 that opposes square end 68 and can be coupled to impact drill 34, impact wrench 42, or another power tool.

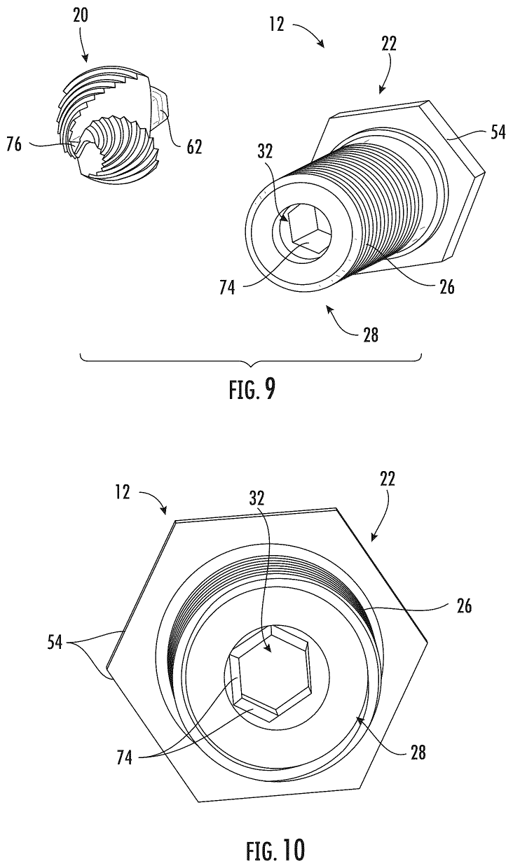

Referring to FIGS. 9-10, details of the bit end 28 of draw stud 12 are shown according to an exemplary embodiment. Step bit 20 includes a pointed or drill end 76 that opposes engagement end 62 that is couplable to draw stud 12. Bore 32 of draw stud 12 includes a plurality of inward facing surfaces 74. In a specific embodiment, bore 32 is hex shaped (i.e., includes six inward facing surfaces). Inward facing surfaces 74 engages with engagement end 62 of step bit 20 and resists rotation of engagement end 62 such that step bit 20 co-rotates with draw stud 12.

Referring to FIG. 11, details of a step bit 120 that can be utilized with knockout punch tool set 10 is shown according to another exemplary embodiment. Step bit 120 includes a pointed or drill end 122 and an opposing engagement end 126 that is couplable to bore 32 at bit end 28 of draw stud 12. Step bit 120 further includes a reamer 124 positioned between drill end 122 and engagement end 126. In practice, a user can make a pilot hole with drill end 122 and wobble the reamer 124 around any sharp edges of the pilot hole allowing for quick and simple removal of the sharp edges of the pilot hole and easier insertion of the draw stud 12 through the pilot hole during the punching process.

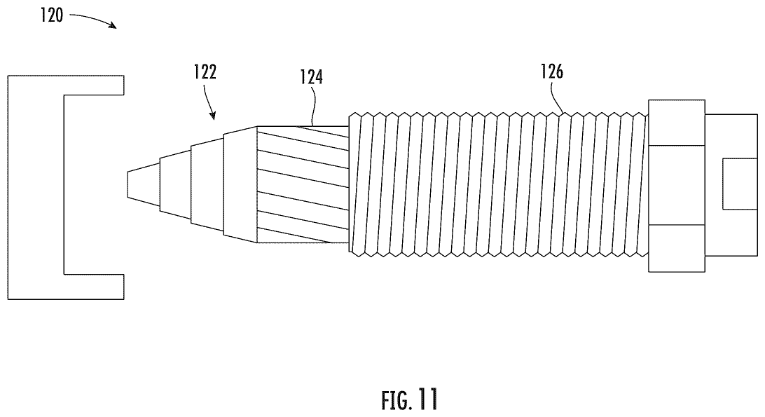

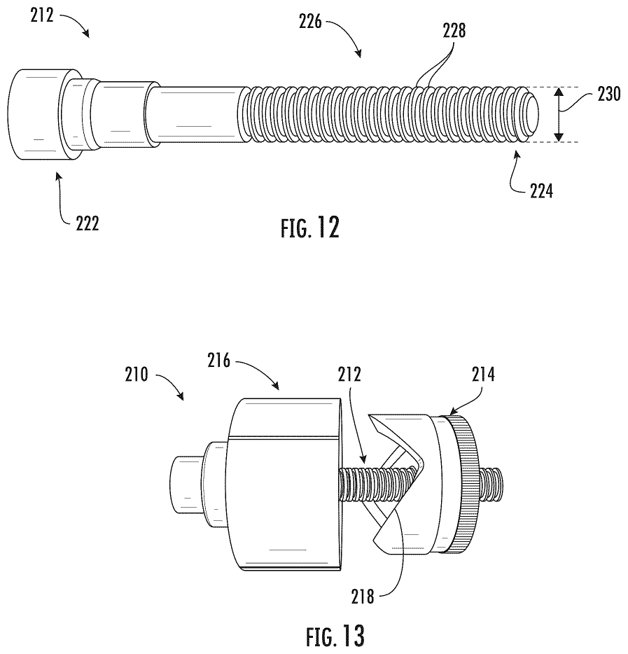

Referring to FIG. 12, details of a draw stud 212 are shown according to another exemplary embodiment. Draw stud 212 is substantially the same as draw stud 12 except for the differences discussed herein. Draw stud 212 can be utilized with knockout punch tool set 10.

Draw stud 212 extends between an engagement end 222 and an opposing front end 224. In various specific embodiments, engagement end 222 is a hex end. Draw stud 212 further includes a threaded section 226 positioned between engagement end 222 and front end 224. Threaded section 226 includes a plurality of threads 228. In various embodiments, threads 228 have a non-square profile. In various specific embodiments, threads 228 are ACME threads. In various specific embodiments, the threaded portion 226 includes a plurality of ACME threads. 228 In other words, in such embodiments, threads 228 have a trapezoidal cross-sectional profile.

Draw stud 212 and specifically a shaft of draw stud 212 includes a dimension shown as a diameter 230. In various specific embodiments, diameter 230 is less than 0.70 inches. In various specific embodiments, diameter 230 is between 0.70 inches and 0.60 inches, specifically between 0.65 and 0.60 inches, and more specifically between 0.64 and 0.61 inches. In various specific embodiments, draw stud 212 has a diameter 230 of about 0.625 inches (e.g., 0.625 inches plus of minus 0.063 inches). As previously discussed, the diameter of draw stud 212 is decreased relative to many other draw stud diameters meaning the required input torque from a powered tool (see e.g., impact drill 34 in FIG. 3, impact wrench 42 in FIG. 4) is reduced. Furthermore, due to the design of threads 228 the speed of punching is increased. In other words, because there are fewer threads per inch, less revolutions are needed to punch through an object.

Referring to FIG. 13, details of a knockout punch tool set 210 is shown according to an exemplary embodiment. Knockout punch tool set 210 includes draw stud 212, a punch 214, and a die 216. As will be generally understood, the punching process includes providing a force between the die 216 and punch 214, such that the punch 214 and specifically cutting end or projection 218 pierces a sheet of material or workpiece and forms a desired aperture within the material. In various embodiments, punch 214 includes internal threads that correspond to threads 228 of draw stud 212. In other words, in such embodiments, punch 214 includes internal ACME threads to engage threads 228 of draw stud 212.

Referring to FIG. 14, details of a knockout punch tool set 310 are shown according to another exemplary embodiment. Knockout punch tool set 310 is substantially the same as knockout punch tool sets 10, 210 except for the differences discussed herein. Knockout punch tool set 310 includes draw stud 312, a punch 314, and a die (see e.g., 16, 216). Draw stud 312 includes threads 328 along a shaft portion. In various embodiments, threads 328 have a non-square profile. In various specific embodiments, threads 328 are ACME threads.

Punch 314 includes a bore 337 that defines an internal surface. The internal surface of bore 337 includes a plurality of threads 338. Threads 338 engage threads 328 of draw stud 312. In various specific embodiments, threads 338 are ACME threads.

Knockout punch tool set 310 further includes a connector, shown as nut 332. In various specific embodiments, nut 332 is a hex nut. Nut 332 includes a bore 334 that defines an internal nut surface. The internal nut surface includes a plurality of threads 336. Threads 336 similarly engage threads 328 of draw stud 312. In various embodiments, nut 332 is treated to improve life. For example, in various embodiments nut 332 is formed from a material configured to maximize life of the nut. In various specific embodiments, nut 332 is heat treated. In various specific embodiments, nut 332 is formed from a material configured to maximize life of the nut and heat treated.

Draw stud 312 and specifically a shaft of draw stud 312 includes a dimension shown as diameter 330. In various specific embodiments, diameter 330 is less than 0.70 inches. In various specific embodiments, diameter 330 is the same as diameter 230. As will be generally understood, the diameter 330 having a reduced size may cause slipping between threads of conventional punches that have a larger diameter bore. As previously discussed, Applicant has found that use of a connector reduces the likelihood of draw stud or punch failure.

In various specific embodiments, draw stud 312 is formed from a material to further reduce draw stud failure. In various embodiments, draw stud 312 if formed from at least one of S7 tool steel, nitrided steel, 4140 steel, nitrided 4140 steel. In various specific embodiments draw stud 312 has a hardness of about 50 HRC (Rockwell Hardness) (e.g., 50 HRC plus or minus 5 HRC).

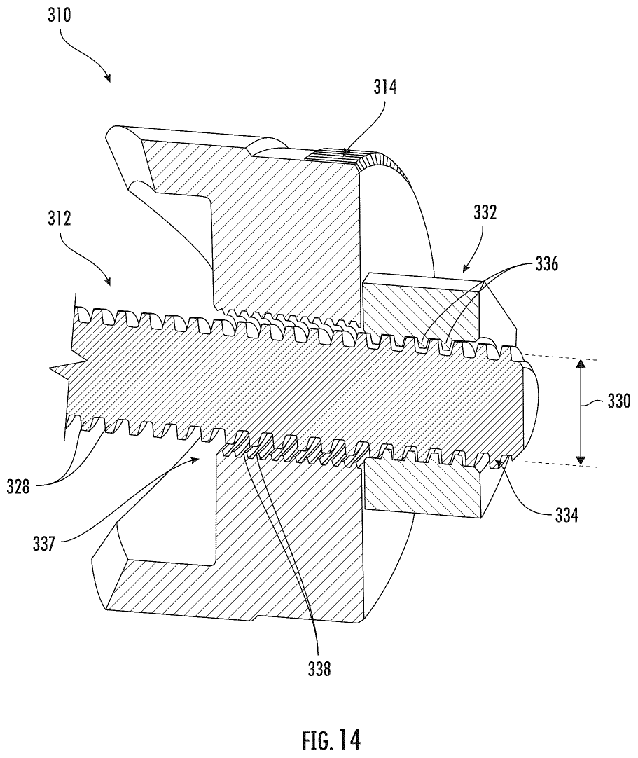

Referring to FIG. 15, details of a knockout punch tool set 410 are shown according to another exemplary embodiment. Knockout punch tool set 410 is substantially the same as knockout punch tool sets 10, 210, 310 except for the differences discussed herein. Knockout punch tool set 410 includes draw stud 412, a punch 414, and a die 416. Punch 414 includes an outward facing surface 440 and a recess 442 sized to receive a connector, shown as nut 432. In specific embodiments, the connector or nut 432 is a hex nut. Recess 442 includes a perimeter 444. In various specific embodiments, perimeter 444 has a number of edges that correspond to the number of edges of nut 432. For example, when nut 432 is a hex nut, perimeter 444 includes six edges.

In various specific embodiments, nut 432 is secured in recess 442 by a locking component. In such embodiments, the locking component is at least one of a ball detent, snap ring, button release, C-ring, O-ring.

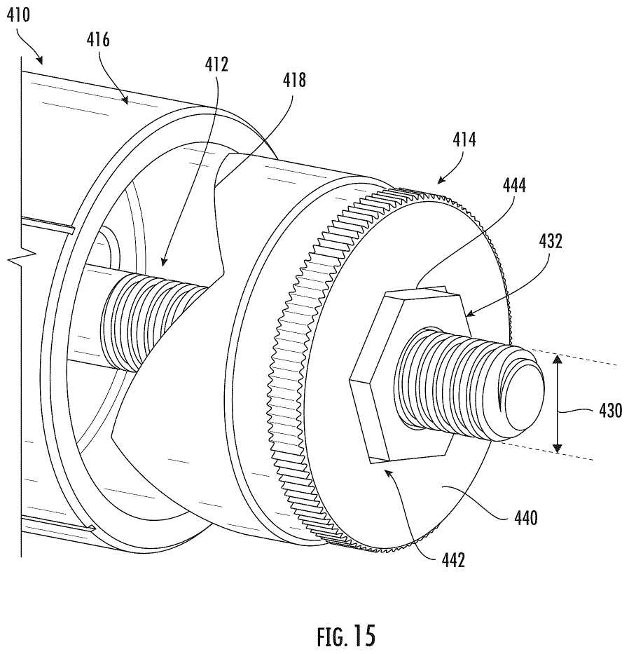

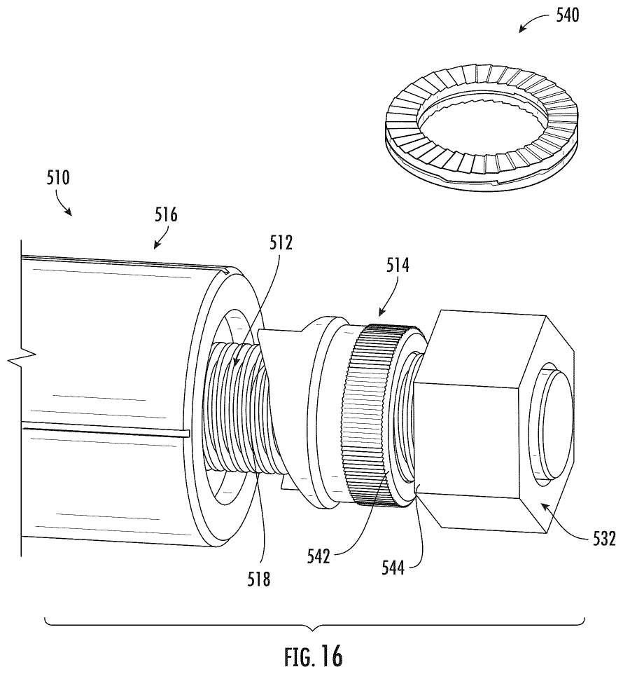

Referring to FIG. 16, is a partially exploded view of a knockout punch tool set 510 is shown according to another exemplary embodiment. Knockout punch tool set 510 is substantially the same as knockout punch tool sets 10, 210, 310, 410 except for the differences discussed herein. Knockout punch tool set 510 includes draw stud 512, a punch 514, a die 516, and a connector shown as nut 532. In various embodiments, the knockout punch tool set 510 includes a spacer, shown as friction pad 540. When knockout punch tool set 510 is assembled, friction pad 540 is positioned between punch 514 and nut 532. As previously discussed, Applicant has found an increase in friction between the punch and connector prevents separation of components.

Punch 514 further includes an outer surface 542. Outer surface 542 faces in a direction of the longitudinal axis of draw stud 512 when knockout punch tool set 510 is assembled. Nut 532 includes an inward facing surface 544 that faces outer surface 542 of punch 514. In various embodiments, fiction pad 540 is positioned between outer surface 542 of punch 514 and inward facing surface 544 of nut 532. In various specific embodiments, outer surface 542 includes knurling features. In various specific embodiments, inward facing surface 544 of nut 532 includes knurling features. In various specific embodiments, both inward facing surface 544 of nut 532 and outer surface 542 of punch 514 include knurling features. In various specific embodiments, a wire, such as aviation safety wire connects nut 532 to punch 514.

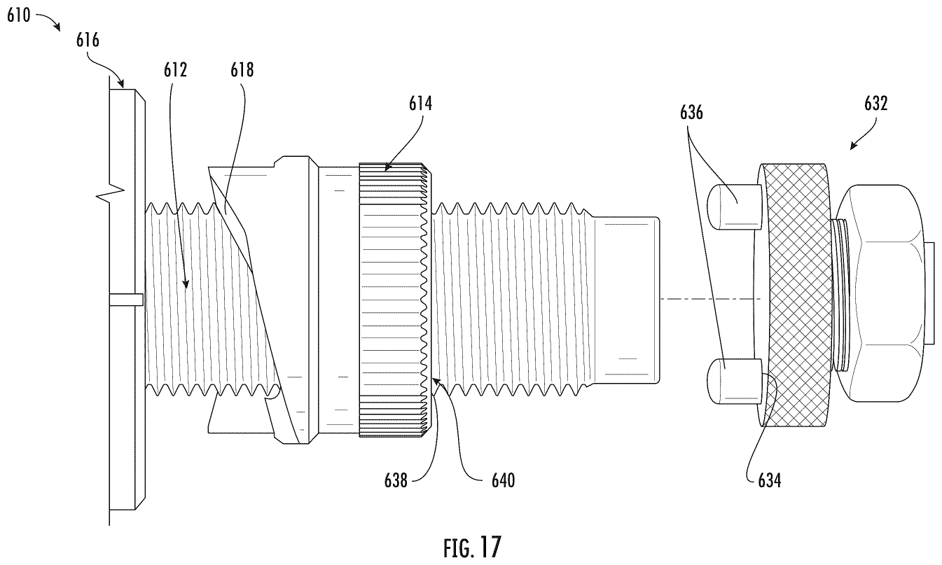

Referring to FIG. 17, details of a knockout punch tool set 610 are shown according to another exemplary embodiment. Knockout punch tool set 610 is substantially the same as knockout punch tool sets 10, 210, 310, 410, 510 except for the differences discussed herein. Knockout punch tool set 610 includes draw stud 612, a punch 614, a die 616, and a connector shown as nut 632. Punch 614 further includes an outer surface 638. Outer surface 638 faces in a direction of the longitudinal axis of draw stud 612 when knockout punch tool set 610 is assembled. Nut 632 includes an inward facing surface 634 that faces outer surface 638 of punch 614.

Inward facing surface 634 of nut 632 and outer surface 638 of punch 614 include mating features to lock nut 632 and punch 614. In other words, mating features on nut 632 and punch 614 resist separation or an increase in distance between nut 632 and punch 614 when the knockout punch tool set 610 is assembled. In the illustrated embodiment, nut 632 and specifically inward facing surface 634 has one or more projections 636 that extend toward punch 614. Punch 614 and more specifically outer surface 638 includes one or more recess 640 configured to receive and engage with the one or more projections 636 of nut 632.

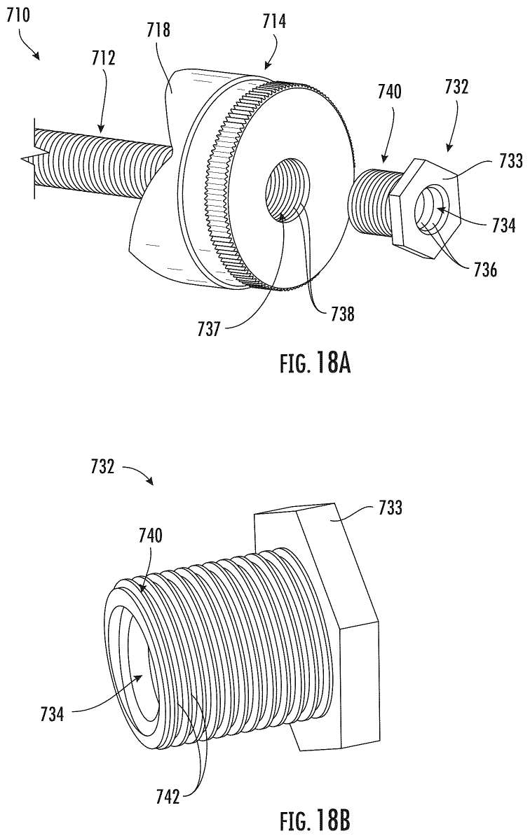

Referring to FIGS. 18A-B, details of a knockout punch tool set 710 are shown according to another exemplary embodiment. Knockout punch tool set 710 is substantially the same as knockout punch tool sets 10, 210, 310, 410, 510, 610 except for the differences discussed herein. Knockout punch tool set 710 includes draw stud 712, a punch 714, a die, and an adapter 732. Adapter 732 is configured to be used with existing punches. Adapter 732 includes a head 733 and a shaft 740. In various specific embodiments, head 733 is a hex shaped head. Adapter 732 further includes a bore 734 with internal threads 736. Shaft 740 includes an outer surface with external threads 742.

The combination of internal threads 736 and external threads 742 allows adapter 732 to connect draw stud 712 and punch 714. In various specific embodiments, adapter 732 is an ACME thread to UNF thread adapter. In other words, in specific embodiments, internal threads 736 are ACME threads configured to engage ACME threads of draw stud 712 while external threads 742 are UNF (“unified fine pitch”) threads configured to engage the UNF threads of punch 714. Similar to the previously discussed consumable nuts, adapter 732 becomes the point of failure or consumable component to prevent having to replace draw stud 712 and/or punch 714.

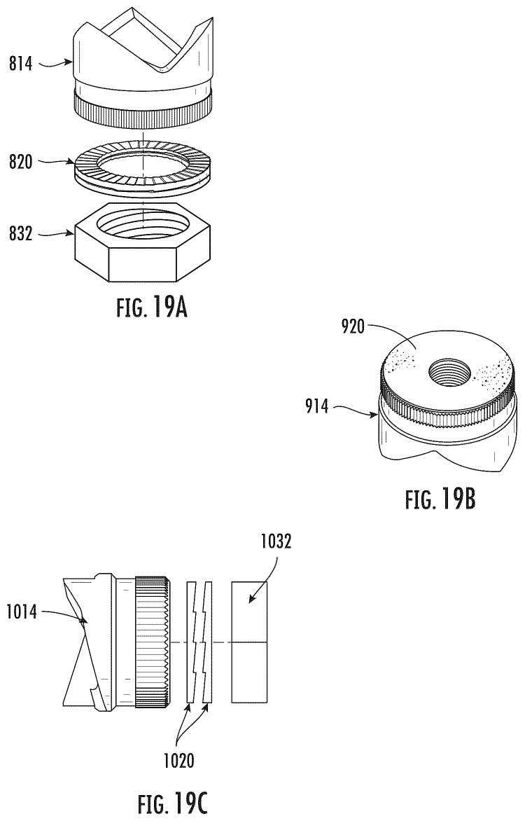

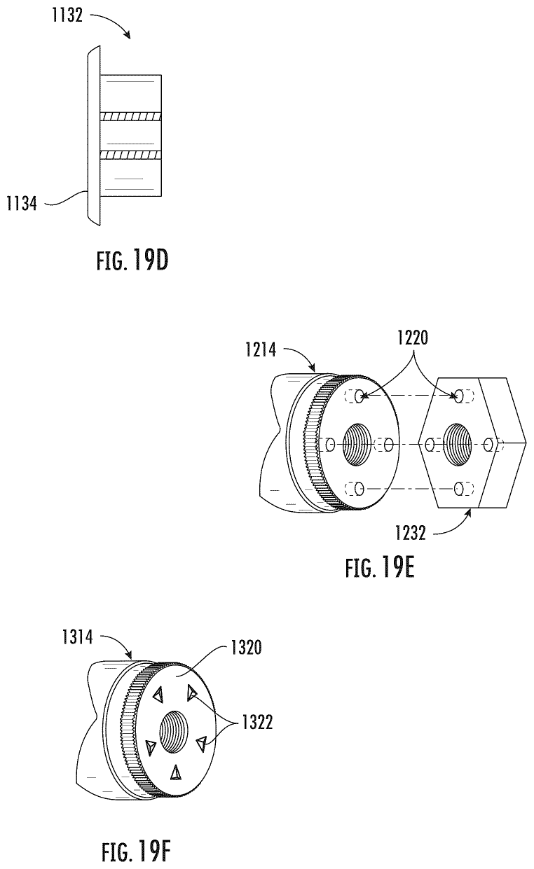

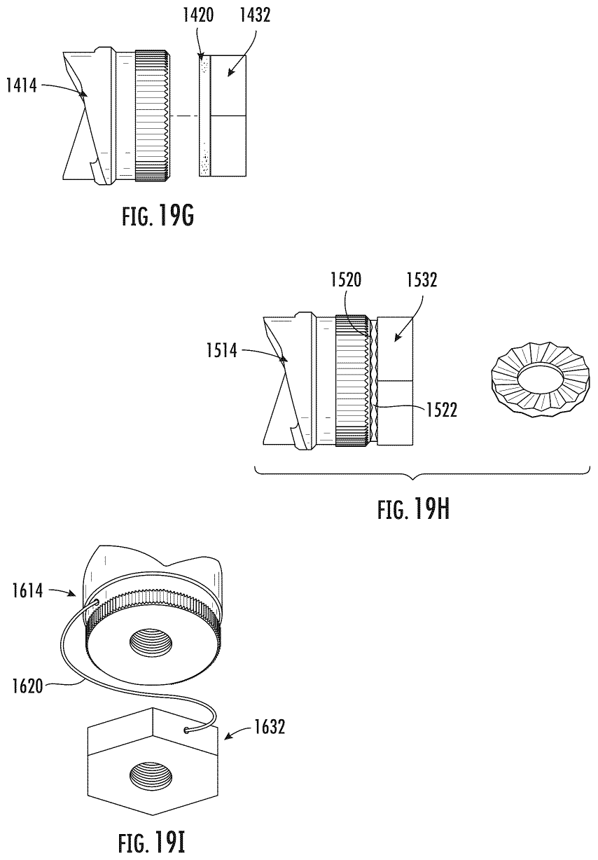

Referring to FIGS. 19A-I, details of various embodiments to increase friction between a nut and punch of a knockout tool set are shown according to exemplary embodiments. As previously discussed, Applicant has found an increase in friction between the punch and connector (nut, adapter, etc.) prevents separation of the components of the knockout tool set. As shown in FIG. 19A, a washer, shown as a lock washer 820 is positioned between a punch 814 and nut 832. As shown in FIG. 19B, a layer 920 is added to an outer surface of punch 914. In specific embodiments, layer 920 is formed from a rubber material. Referring to FIG. 19C, a sticking material 1020 is coupled to both punch 1014 and nut 1032. In various specific embodiments, the sticking material 1020 is VELCRO®.

Referring to FIG. 19D, a nut 1132 includes a flanged portion 1134. Flanged portion 1134 is configured to engage with a punch. Applicant has found the increased surface area increases friction between nut 1132 and the punch. Referring to FIG. 19E, punch 1214 and/or nut 1232 include magnets 1220 to prevent separation of punch 1214 from nut 1232. As shown in FIG. 19F, punch 1314 includes a surface 1320 that is abrasive. In other words, surface 1320 includes textured or roughened portions 1322.

Referring to FIG. 19G, nut 1432 includes a spacer 1420 on a surface that faces punch 1414. In specific embodiments, spacer 1420 is a rubber spacer. Referring to FIG. 19H, locking teeth on nut 1532 and/or punch 1514 are used to resist separation of nut 1532 and punch 1514. As shown in FIG. 19A, a wire 1620 is used to connect punch 1614 and nut 1632. In specific embodiments, wire 1620 is aviation wire.

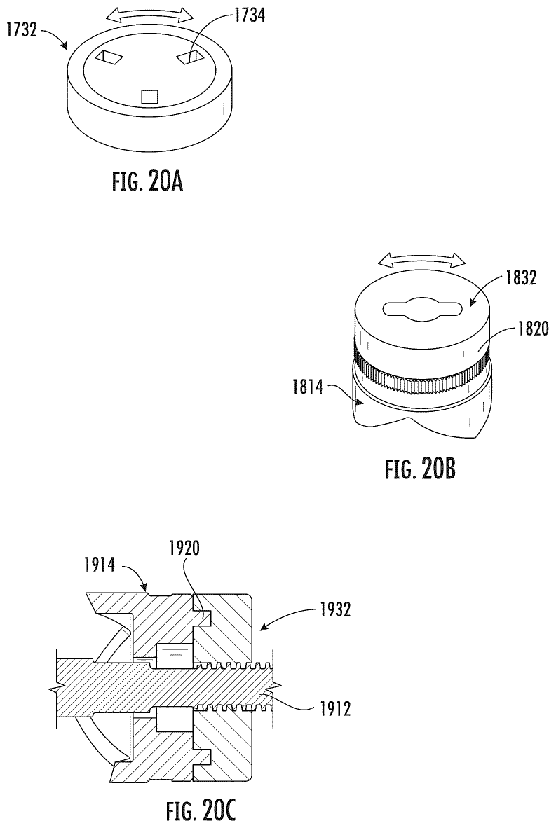

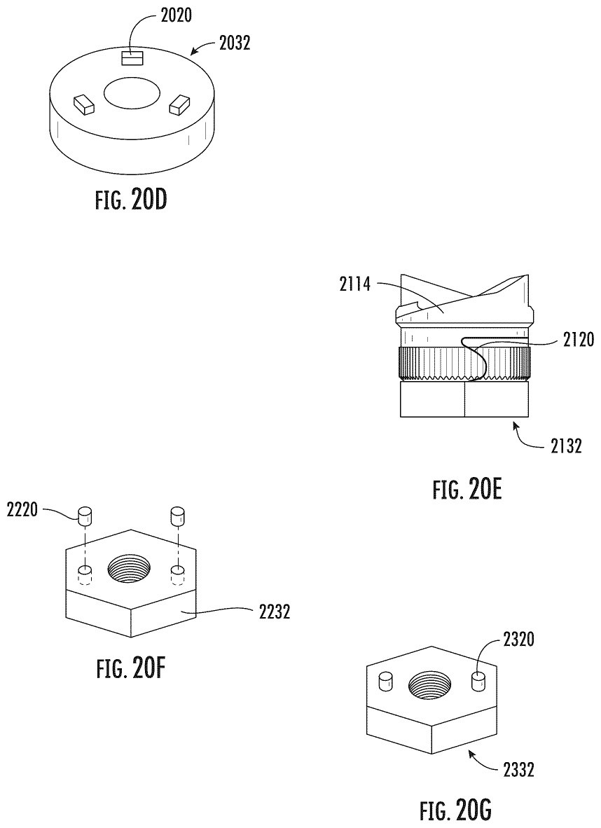

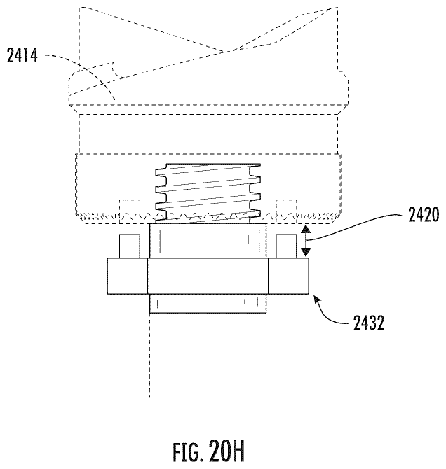

Referring to FIGS. 20A-H, details of various embodiments to quickly lock a nut and punch of a knockout tool set are shown according to exemplary embodiments. Referring to FIG. 20A, nut 1732 has a collar 1734 that a user can twist to clamp nut 1732 onto the punch. As shown in FIG. 20B, nut 1832 has a keying feature 1820 that allows for mounting to punch 1814 when twisted. Referring to FIG. 20C, punch 1914 includes one or more pins 1920 configured to engage with nut 1932.

Referring to FIG. 20D, nut 2032 includes a plurality of locking tabs 2020 configured to engage with the punch. As shown in FIG. 20E, punch 2114 and nut 2132 include a puzzle feature 2120. In other words, punch 2114 and nut 2132 lock together due to a jigsaw feature or edges that engage each other. As shown in FIGS. 20F-G pins 2220 and pins 2320 are used to lock nut 2332 to a punch. In FIG. 20F, pins 2220 couple to recesses on nut 2332. In contrast, in FIG. 20G, pins 2320 extend from nut 2332 to engage the punch. Referring to FIG. 20H, projections 2420 extend from nut 2432 to engage and couple to corresponding recesses on punch 2414.

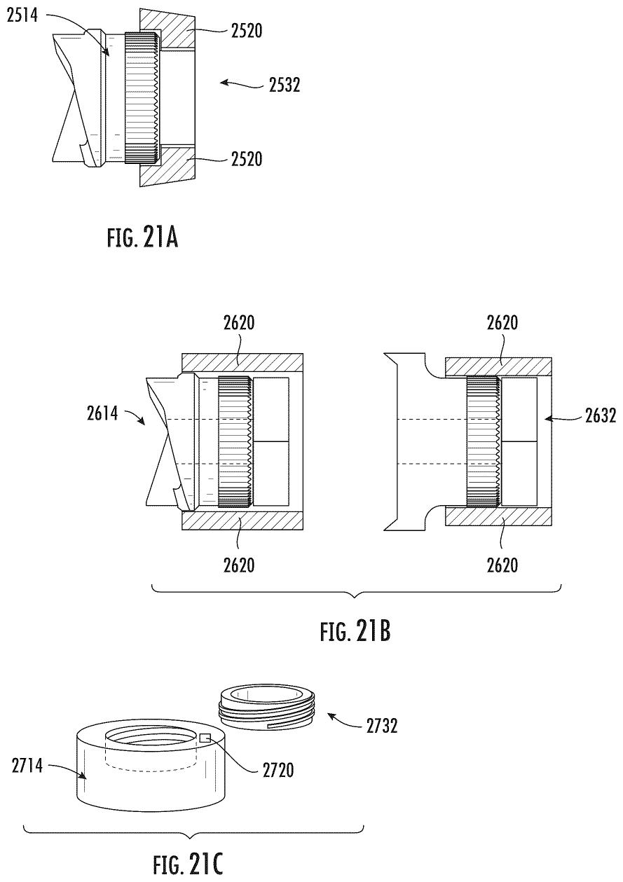

Referring to FIGS. 21A-C, details of various embodiments to couple a nut and punch of a knockout tool set are shown according to exemplary embodiments. Referring to FIG. 21A, a connector 2520 couples nut 2532 to punch 2514. Referring to FIG. 21B, a connector, shown as sleeve 2620 is used to couple nut 2632 to punch 2614. Referring to FIG. 21C, punch 2714 includes a bore 2720 configured to receive nut 2732 as an insert. In various specific embodiments, nut 2732 and bore 2720 of punch 2714 are threaded.

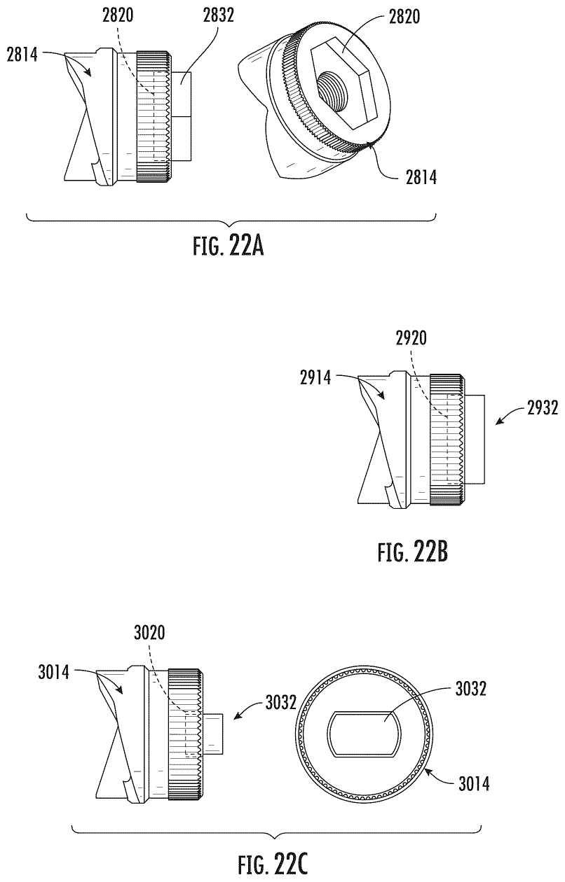

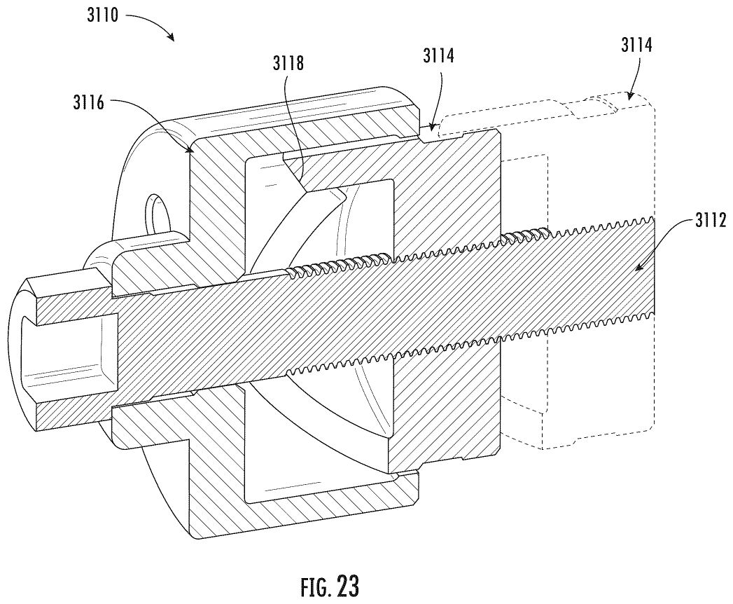

Referring to FIGS. 22A-C, details of various embodiments to a recessed feature on punch of a knockout tool set are shown according to exemplary embodiments. Referring to FIG. 22A, punch 2814 includes a recess 2820 in an outer surface. Recess 2820 is configured to receive and secure nut 2832 to punch 2814. In various specific embodiments, nut 2832 is a hex nut and recess 2820 has a hexagonal shape corresponding to nut 2832. Referring to FIG. 22B, punch 2914 has a recess 2920 configured to receive a nut, shown as a square nut 2932. Referring to FIG. 22C, punch 3014 has an inset nut 3032.

FIG. 23 a cross-sectional view of a knockout tool set 3110 moving from a first position (illustrated in dashed lines) to a second position is shown according to an exemplary embodiment. As previously discussed, the punch 3114 frequently has energy and continues to move along the shaft of the draw stud 3112 after a punch is complete, resulting in unwanted engagement between punch 3114 and the die 3116. In other words, the impacts between the die 3116 and punch 3114 may deform the punch 3114 and/or damage the punch 3114, specifically cutting end or projections 3118 and die 3116.

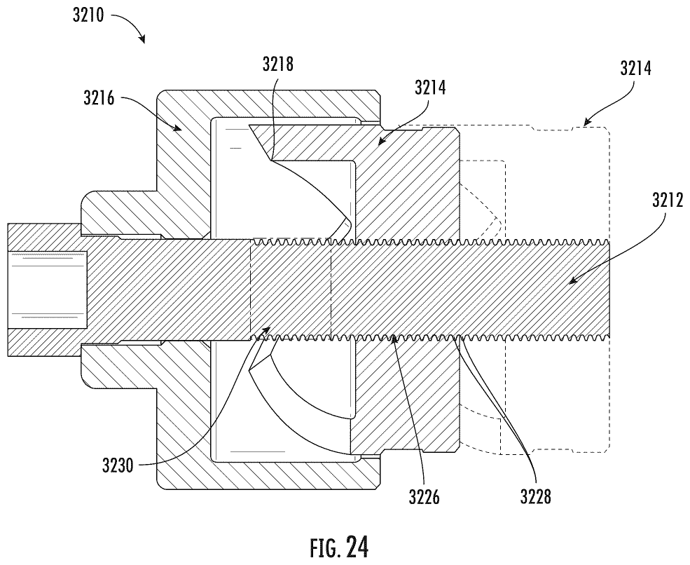

FIG. 24 a cross-sectional view of a knockout tool set 3210 moving from a first position (illustrated in dashed lines) to a second position is shown according to an exemplary embodiment. Knockout punch tool set 3210 is substantially the same as knockout punch tool sets 10, 210, 310, 410, 510, 610, 710 except for the differences discussed herein. As discussed above, in order to prevent unwanted engagement between punch 3214 and die 3216, draw stud 3212 and specifically the shaft of draw stud 3212 includes a threadless zone 3230. When punch 3214 has punched through an object, punch 3214 stops moving toward die 3216 when the threadless zone 3230 is reached.

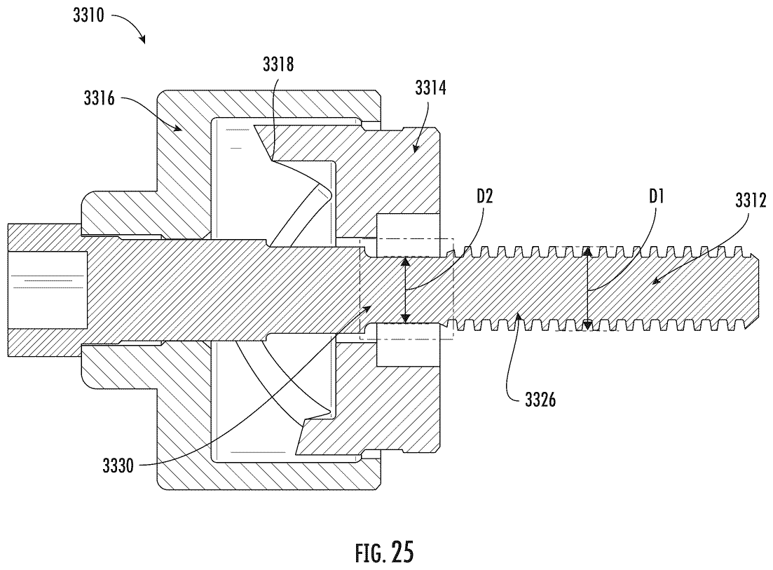

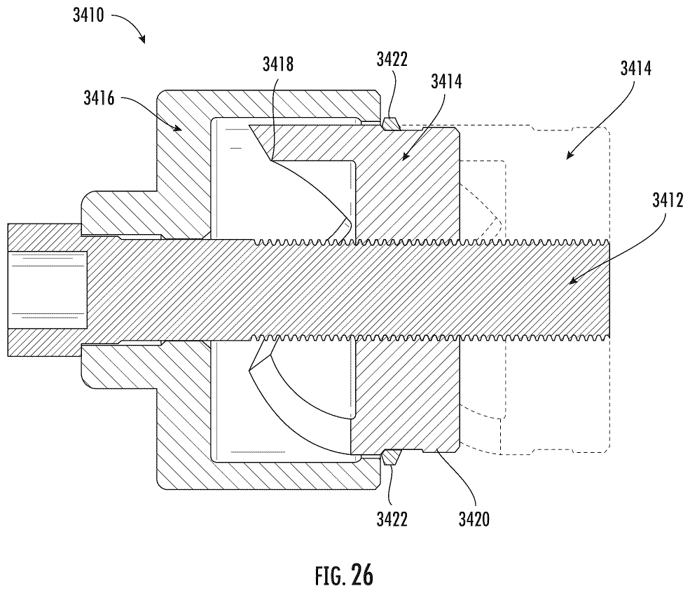

FIG. 25 a cross-sectional view of a knockout tool set 3310 with a punch 3314 moving toward a die 3316 is shown according to an exemplary embodiment. Knockout punch tool set 3310 is substantially the same as knockout punch tool sets 10, 210, 310, 410, 510, 610, 710, 3210 except for the differences discussed herein. As discussed above, in order to prevent unwanted engagement between punch 3314 and die 3316, draw stud 3312 and specifically the shaft of draw stud 3312 includes a threadless zone 3330. In various specific embodiments, threadless zone 3330 also includes a reduced diameter. A threaded portion 3326 of draw stud 3312 includes a first dimension shown as diameter D1 and threadless portion 3230 includes a second dimension shown as diameter D2. In various embodiments, D2 is less than D1.

When punch 3314 has punched through an object, punch 3314 stops moving toward die 3316 when the threadless zone 3330 with the reduced diameter is reached. In such embodiments, the punch 3314 spins freely after punching through the object and passing into the threadless zone 3330. Further, the spinning of punch 3314 indicates to the user the end or completion of the punching operation. As noted above, because punch 3314 spins rather than advancing further in the direction of die 3316, reduced and/or no unwanted engagement between punch 3314 and die 3316 occurs.

FIG. 26 a cross-sectional view of a knockout tool set 3410 moving from a first position (illustrated in dashed lines) to a second position is shown according to an exemplary embodiment. Knockout punch tool set 3410 is substantially the same as knockout punch tool sets 10, 210, 310, 410, 510, 610, 710, 3110 except for the differences discussed herein. As discussed above, in order to prevent unwanted engagement between punch 3414 and die 3416, punch 3114 includes a flange 3422 to prevent further movement of punch 3414 toward die 3416. When punch 3414 has punched through an object, punch 3414 stops moving toward die 3416 when the flange 3422 engages an end of die 3416. In various embodiments, flange 3422 is an annular flange that extends around a circumference of punch 3414. In other specific embodiments, flange 3422 includes a plurality of projections equally spaced around the circumference of punch 3414. Due to the increased dimensions of punch 3414, after punching through an object punch 3414 will have a dimension too large to fit though the new hole and will be backed off the draw stud 3412 by the user.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed:

1. A knockout punch tool set comprising:
a draw stud comprising:
a driving end, the driving end comprising a recess;
a front end opposing the driving end; and
a threaded portion positioned between the driving end and the front end;
a punch, the punch couplable to the draw stud;
a die, the die couplable to the draw stud;
a drive, the drive positioned within the recess of the driving end; and
a powered tool configured to rotate the drive.

2. The knockout punch tool set of claim 1, wherein the powered tool is one of an impact drill and an impact wrench.

3. The knockout punch tool set of claim 1, wherein the drive is a square drive.

4. The knockout punch tool set of claim 1, wherein the driving end of the draw stud further comprises a plurality of outer surfaces.

5. The knockout punch tool set of claim 4, wherein the plurality of outer surfaces comprises six outer surfaces.

6. The knockout punch tool set of claim 1, wherein the driving end has a generally hexagonal shape with the recess defined in a middle of the driving end.

7. The knockout punch tool set of claim 6, wherein the driving end is configured to be engaged by a manual tool.

8. The knockout punch tool set of claim 7, wherein the manual tool is a ratchet wrench.

9. The knockout punch tool set of claim 1, wherein the draw stud further comprises a bore in the front end, and wherein the bore is couplable to a step bit.

10. The knockout punch tool set of claim 9, wherein the step bit comprises:
a drilling end;
an engagement end that opposes the drilling end, the engagement end coupled to the bore of the draw stud; and
a reamer positioned between the drilling end and the engagement end.

11. A draw stud for a knockout punch tool comprising:
a driving end, the driving end comprising a recess;
a front end opposing the driving end, the front end comprising a bore; and
a threaded portion positioned and extending between the driving end and the front end;
wherein the driving end has a polygonal shape.

12. The draw stud of claim 11, wherein the recess comprises four inward facing surfaces.

13. The draw stud of claim 11, wherein the driving end comprises six radially outward facing surfaces.

14. The draw stud of claim 11, wherein the threaded portion of the draw stud includes a plurality of ACME threads.

15. A knockout punch tool set comprising:
a draw stud comprising:
a driving end;
a front end opposing the driving end; and
a threaded portion positioned between the driving end and the front end, the threaded portion extending along a longitudinal axis of the draw stud;
a punch, the punch coupled adjacent to the front end of the draw stud;
a connector coupled to the front end of the draw stud, wherein the punch is positioned between the connector and the draw stud;
a die, the die coupled adjacent to the driving end of the draw stud; and
a tool configured to rotate the draw stud.

16. The knockout punch tool set of claim 15, wherein the connector is a hex nut.

17. The knockout punch tool set of claim 15, wherein the threaded portion of the draw stud includes a plurality of threads having a trapezoidal cross-sectional profile.

18. The knockout punch tool set of claim 15, wherein the punch comprises:
an outer surface facing in a direction of the longitudinal axis of the draw stud; and
a recess defined in the outer surface of the punch, the recess sized to receive the connector.

19. The knockout punch tool set of claim 15, wherein the punch comprises:
an outer surface facing away from the die;
an inner surface facing toward the die; and
a spacer positioned between the outer surface of the punch and the connector.

20. The knockout punch tool set of claim 15, wherein the driving end of the draw stud further comprises a recess, and wherein the recess is shaped to receive a square drive.
